(19) United States
(12) Patent Application Publication
(10) Pub. No.: US 2012/0096088 A1
(43) Pub. Date: Apr. 19, 2012

(54) SYSTEM AND METHOD FOR DETERMINING SOCIAL COMPATIBILITY

(76) Inventor: Sherif FAHMY, Morristown, NJ (US)

(21) Appl. No.: 13/273,370

(22) Filed: Oct. 14, 2011

Related U.S. Application Data
(60) Provisional application No. 61/392,999, filed on Oct. 14, 2010.

(51) Int. Cl. G06F 15/16

(52) U.S. Cl. 709/204

(57) ABSTRACT

A device, system and method for determining user compatibility. Information may be received recording the usage of media by two or more users at associated user devices. The recorded media usage for the users may be compared. A measure of compatibility may be determined between the two or more users based on the comparison.

### REFERENCE TO RELATED APPLICATIONS

This patent application claims priority from U.S. provisional patent application Ser. No. 61/392,999 filed Oct. 14, 2010, which is incorporated herein by reference in its entirety.

### FIELD OF THE INVENTION

Embodiments of the present invention relate to social networking applications. In particular, embodiments of the present invention relate to social networking applications for determining the compatibility of multiple users.

### BACKGROUND OF THE INVENTION

Social networking services provide communication for vast networks of users. Specific networking applications allow users to chat, trade music, and meet friends online. Users may connect with each other by requesting other users and some social networking applications may make recommendations for a user to connect with other individuals, e.g., with similar interests or friends.

However, such recommendations are based principally on information these users provide themselves and thus, may be biased. Conventional matchmaking services typically use a similar question and answer form and match users with similar responses. Such services have no way to definitively verify that the information provided by the user is accurate (e.g., it is difficult to tell if a user actually enjoys a book or likes a song). In fact, it is generally accepted that users will embellish their positive traits on dating or social network sites.

### SUMMARY

In an embodiment of the invention, information may be received recording the usage of media by two or more users at associated user devices, the recorded media usage for the users may be compared, and a measure of compatibility may be determined between the two or more users based on the comparison.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 schematically illustrates a system for determining social media compatibility in accordance with an embodiment of the invention;

FIGS. 2A-2V schematically illustrate user interfaces for operating a social media compatibility application in accordance with embodiments of the invention;

FIG. 2W schematically illustrates an application map showing the interrelationships between user interfaces of FIGS. 2A-2V in accordance with embodiments of the invention;

FIGS. 3A-3C schematically illustrate other examples of user interfaces for operating a social media compatibility application in accordance with embodiments of the invention; and

FIG. 4 is a flowchart illustration of a method in accordance with an embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

Embodiments of the invention provide a system and method for automatically determining user compatibility based on recorded or tracked usage of the users' media. Determining compatibility based on the users' usage of their media may provide a more accurate impression of the users' tastes than determining compatibility based simply on the content of their media. For example, some users have music they never listen to. Other users simply dump entire media collections from a friend's library onto a storage device. By considering media usage, such embodiments may prevent a user who copies a friend's media library, from copying their friend's “personality.” By considering users' media usage or playing, embodiments of the invention may provide a true measure of user's interests and compatibility. Furthermore, by recording the users' media usage automatically and passively, for example, without the user's active input, embodiments of the invention may avoid user bias for objective compatibility screening. Compatibility between two users, or among users, may be a prediction or one indication as to how socially compatible the users are with each other, e.g., how well the users might get along socially or how much the users might like each other.

Embodiments of the invention may include a processor or scanner to passively scan users' media databases and analyze their media usage or access to determine user compatibility. Media usage or access may include, for example, playing, listening to, or viewing a video or song, specifically requesting a video or song, requesting or downloading a podcast or other media file, etc. Each “use” or “play” may be measured discretely, e.g., if a user listens to a specific song five times, that may count for five uses. When used herein, play or a play may be used interchangeably with “use”, but use may include other aspects, such as downloading or purchase. A user's media databases may include media stored locally on one or more personal computing devices (e.g., a smart phone, desktop computer, external hard drive, etc.) as well as media accessed remotely (e.g., over the Internet, via web servers). Media may include, for example, music, movies, videos, television programs, audio or video recordings, or other media. Media accessed remotely or on-line may include television and movies (e.g., from Netflix.com), music (e.g., from Pandora.com), podcasts, e-books (e.g., from OnRead.com) or any other media type, whether streaming, downloaded or otherwise accessed. In one embodiment, a passive sniffer or web crawler may analyze the remote media. In another embodiment, a user may provide a direct link between the compatibility application and each of the user's accounts at an Internet-based media provider (e.g., via a provider application programming interface (API), or an application or “app”, an application tailored to a mobile device or other device). The usage of local media (stored in the user's device) may be automatically recorded, e.g., by a media player application and/or a memory unit where the media is stored. For example, some media players, such as the iTunes media player, store for example in a database how often a user accesses or plays each song.

Embodiments of the invention may determine a score, rank or statistical data measuring the compatibility of two or more users. The compatibility score may measure, each user's media (e.g., by genres, artists, songs, etc.), and in addition to or separately, also each user's unique usage, accessing or playing of that media (e.g., media most accessed or played, variety or diversity or genres used, frequency of use, if the user is the original creator of the media file, etc.). A user's media usage measurement may be a linear combination (or other function) of each of the user's media items (e.g., song, genre, etc.), each weighted by a usage coefficient measuring the amount the user uses that item. A weight may be individually assigned, for example, to each single media file (e.g., a song, video, e-book, etc.) or group of multiple media files (e.g., genres, styles, artists, time periods, formats, etc.) In some embodiments, the user's media usage measurement may be a unique “finger-print” or profile of the user's style. This unique profile may be analyzed and compared for multiple users, e.g., using a best-fit or root mean square approximation, to identify users with similar “finger-prints” or an above threshold compatibility score.

Embodiments of the invention may provide a single compatibility test (e.g., analyzing the user's media library based on a single predefined set of criteria) or multiple tests for measuring different types of compatibility (e.g., for musical taste vs. literary taste or for friends vs. romantic partners). One of the multiple tests may be selected, e.g., according to the specified task, or multiple tests may be used together, e.g., according to different algorithms to define an overall compatibility from which a highest, lowest, average or most-compatible measure may be used.

The output of the compatibility test(s) may be a single compatibility score or a more complex statistical analysis. For example, the compatibility output may show each user the reason why another user is or is not compatible. In one example, the compatibility output may list or rank compatible and/or incompatible media such as, books, music, etc. For example, the compatibility output may read: “User A is compatible based on: Twelfth Night (book), The Clash (music style: Punk), and is incompatible based on: Harry Potter (book), Ella Fitzgerald (music style: Jazz).” In some embodiments, the identity of matching user(s) may be kept confidential or hidden from a user until a condition is met, for example, one or both users accept the other or agree to pay a service fee to reveal the other user's identity.

Some embodiments may provide talking points or tips for discussion. For example, users with a matching media category may be provided with each other user's differences or discrepancies within that shared category. The user may discuss these differences, for example, to learn from each other or to explore their unique interpretations of a shared interest.

In addition to compatibility testing between users, embodiments of the invention may analyze an individual user's personality type or media proficiency based on their media collection and its usage. For example, each user's media proficiency may be ranked based on the size of their media database and the variety of the media they access. A proficiency score or profile may be provided, for example, as part of a user's profile, on a social networking website. Users may search each others' profiles, for example, to return list of users most closely matching search criteria. Search criteria may include, for example, users' proficiency in each genre, specific media used, etc., such as, “proficient in jazz,” “proficiency in non-fiction similar to my proficiency,” “read Faulkner but not Hemingway,” etc.

As a user's media usage changes over time, so too does their proficiency level and compatibility with other users. Some embodiments of the invention may track and update user profile and/or compatibility with other users in an ongoing basis, for example, periodically or each time a new media item is used. Further embodiments may allow a user to “watch” other users, for example, to predict, based on the other users' media usage, if each other user will like or dislike a new media item. Accordingly, users may watch other users whose tastes or style they trust to provide predictive or virtual guidance for new media. Some embodiments may also predict how a new media item will affect the user's compatibility with the other users.

Embodiments of the invention may be implemented as hardware or software executed by a processor, for example, as an application or plug-in installed on any handheld or desktop computing device. In another embodiment, user profiles may be programmed as a radio frequency identification (RFID) tag, bar code or other electronic label. Two or more devices may connect or communicate to determine compatibility, for example, using a blue-tooth or local area connection. Users may simply compare (for example “pound”) devices, or initiate a compare operation on one or more devices, with other users and read out the compatibility results (which may be for example displayed on a display), for example, in a party or social environment. A “pound” action may activate a pound API, application of app installed on each device to initiate a compatibility test or transfer information between the devices when the devices touch or are near. User initiation may involve for example, causing a device to execute an app or application. User initiation or a pound operation may cause the transfer of user media data, user usage data, or a derived measure or summary of such data to, e.g., a remote server, or to another user device.

Some embodiments of the invention may include geo-location capabilities, for example, to locate a device on which an application runs or is executed and to find local or nearby compatible user devices. In one example, devices with global positioning system (GPS) capability may find other devices in the same area or room that use the compatibility service or software.

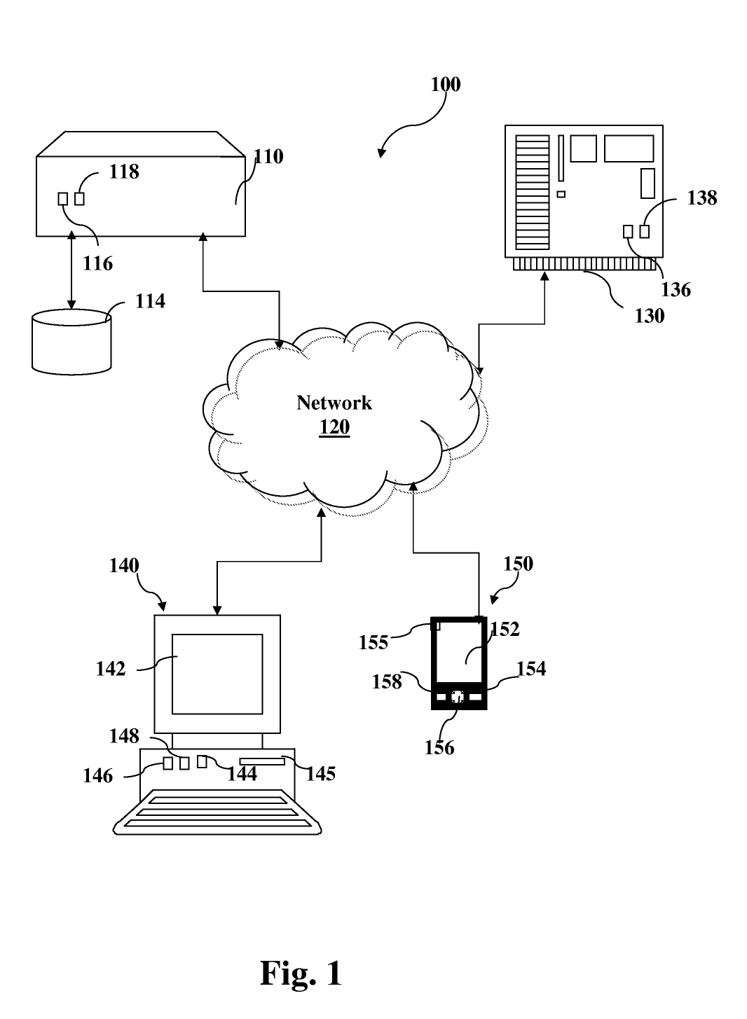

Reference is made to FIG. 1, which schematically illustrates a system 100 for determining social media compatibility in accordance with an embodiment of the invention.

System 100 may include user devices 140 and 150 adapted to access and/or play digital media. Devices 140 and 150 may include computer devices, mobile devices, portable media players (PMPs), digital audio players (DAP), cellular telephones, smart phones, personal digital assistants (PDAs), or any other devices capable of playing digital media. Digital media may include music, video, images, multi-media data, e-books, television, video games, Internet data, etc. User devices 140 and 150 may include media player software or applications (e.g., the iTunes media player) and/or hardware interfaces for playing the digital media.

System 100 may include one or more media servers 110 for hosting and distributing digital media over a network 120, such as the Internet. Media server 110 may be a media service, such as, Netflix, Pandora, lastfm, etc. Media server 110 may be connected to a media storage database 114 storing and recording media usage information for each user and/or user device 140 and 150. User devices 140 and 150, e.g., controlled by users, may download, stream or otherwise retrieve media hosted by media servers 110 via network 120.

System 100 may include an analysis module 130 to determine the social media compatibility of two or more user devices 140 and 150 or of the users operating or owning the devices. The usage of media by user devices 140 and 150 may be recorded, for example, by user devices 140 and 150 themselves (e.g., via media players and/or applications executed by media player applications software 145 and 155, respectively) or by analysis module 130 (e.g., using a passive sniffer to record media on a local media player or a web crawler to record media streaming over the Internet). Analysis module 130 may be implemented remotely from devices 140 and 150, e.g., as a remote server connected via network 120, and/or locally, e.g., as an application or plug-in installed in devices 140 and 150. Analysis module 130 may be software or hardware implemented.

Network 120, which connects media server 110, analysis module 130, and/or user devices 140 and 150, may be any public or private network such as the Internet. Access to network 120 may be through wire line, terrestrial wireless, satellite or other systems. More than one network 120 may be used to access different media formats and/or information sources with different accessibility or security restrictions. In one example, user devices 140 and 150 may access media servers 110 via the Internet and each other via a blue-tooth connection.

Media server 110, analysis module 130, client computer 140, and user devices 140 and 150, may include one or more controller(s) or processor(s) 116, 136, 146, and 156, respectively, for executing operations and one or more memory unit(s) 118, 138, 148, and 158, respectively, for storing media and/or instructions (e.g., software) executable by a processor, for example for carrying out methods as disclosed herein. Processor(s) 116, 136, 146, and 156 may include, for example, a central processing unit (CPU), a digital signal processor (DSP), a microprocessor, a controller, a chip, a microchip, an integrated circuit (IC), or any other suitable multi-purpose or specific processor or controller. Memory unit(s) 118, 138, 148, and 158 may include, for example, a random access memory (RAM), a dynamic RAM (DRAM), a flash memory, a volatile memory, a non-volatile memory, a cache memory, a buffer, a short term memory unit, a long term memory unit, or other suitable memory units or storage units. User devices 140 and 150 may include displays 142 or 152 (e.g., such as a monitor or screen) for displaying to users media provided by media server 110 and/or compatibility applications provided by analysis module 130.

Analysis module 130 may analyze user devices 140 and 150 usage (e.g., playing, access) of media from local memory unit(s) 148 and 158 and/or remote memory unit(s) 118 to determine user compatibility. Analysis module 130 may receive information recording the usage of media by two or more users at associated user devices, compare the recorded media usage for the users, and determine a measure of compatibility between the two or more users based on the comparison. Analysis module 130 may determine if the users are compatible if the comparison defines a sufficiently close (e.g., above threshold) media usage between user devices 140 and 150.

User devices 140 and 150 may include geo-location modules 144 and 154 to search for other users' devices operating the compatibility test.

Other or different devices and connections may be used therebetween.

Embodiments of the invention provide a social media compatibility tool (e.g., analysis module 130 of FIG. 1), which may be implemented, for example, as a smart phone application, an online service, a computer program, a web widget, etc., running on two or more user devices (e.g., user devices 140 and 150 of FIG. 1). The compatibility tool may determine the users' musical tastes (e.g., by analyzing the play lists and loaded music and other media files in the user devices) and then compare that tastes. The compatibility tool may determine if the two or more users have similar tastes and likes. The compatibility tool may be executed automatically and “on-the-fly,” for example, so that users may download the application and immediately get comparison results with other users. The compatibility tool may also be executed passively, for example, scanning and analyzing the users' audio database and players for personal usage data without the user's input. The two user devices may identify each other via direct communication (e.g., over a blue-tooth or Internet connection) or indirect communication via an intermediary device (e.g., analysis module 130 of FIG. 1). A compare button may trigger a compatibility test between the devices and, for example, transfer the tastes or compatibility results from one device to the other. In one embodiment, data transferred between users may be destroyed after the comparison, for example, to bolster privacy.

A user interface may display the comparison results, for example, only on the initiating device or on both compared user devices, e.g., on displays 142 and/or 152. The user interface may display a compatibility rating, specific media genres, styles and/or artists that the users have in common, and/or gaps or discrepancies in the media on each device within a matching genre or for a matching artist. The user interface may automatically provide users with a link or redirect a web browser to a media distributor or media information website (e.g., media servers 110 of FIG. 1, such as iTunes), for example, for the users to access, purchase or obtain information about this missing media or to add the media to a “wish-list,” “online shopping cart” or bookmark/flag the media for later viewing. A service may charge a fee for connecting users with distributors, for example, using a preset fee per connection or a fee based on the products purchased in that connection.

The interface on a user's device may provide an analysis or musical profile(s) for themselves and/or other users, for example, to gain insight into the major characteristics of their tastes (e.g., favorite genre, most played songs, etc.). While viewing a list or description of their favorite songs, for example, the user interface may provide information for particular songs, lyrics, and trivia facts (e.g., based on the songs release date) or links to download alternate versions of the song, ring-tones, band memorabilia or other related products.

The application may store a complete history of each compatibility test or “comparison” with another user, for example, so the user may review past comparisons with specific people.

A link to the compatibility application user account may be provided, e.g., via an icon, in the user's other social media accounts, such as Facebook, Twitter, etc. The icon may list the user's “musical score” (e.g., a measure of the user's musical proficiency based on their library size and variety) or “comparison counter” (e.g., a number of unique comparisons that user has accumulated). In some embodiments, users may be provided with incentives, such as free media or entry into contests, when they achieve a threshold number of comparisons, for example, to encourage usage of the application.

Some embodiments provide a geo-location feature (e.g., via geo-location modules 144 and 154 of FIG. 1) to locate other users in a local area that are running or executing the compatibility application or subscribe to a compatibility service. The devices may use a blue-tooth or Wi-Fi connection to find each other or may update their live location to a remote server (e.g., analysis module 130 of FIG. 1) via an Internet connection. Geo-location may allow users to be informed of other users in their vicinity that have installed or are running the same compatibility application to test if they have matching tastes. Messages to initiate a meeting may be passed via a blue-tooth messaging service or the remote server. In some embodiments, users or user devices may be indexed under an anonymous identification (ID) code so that users do not see any personal contact information.

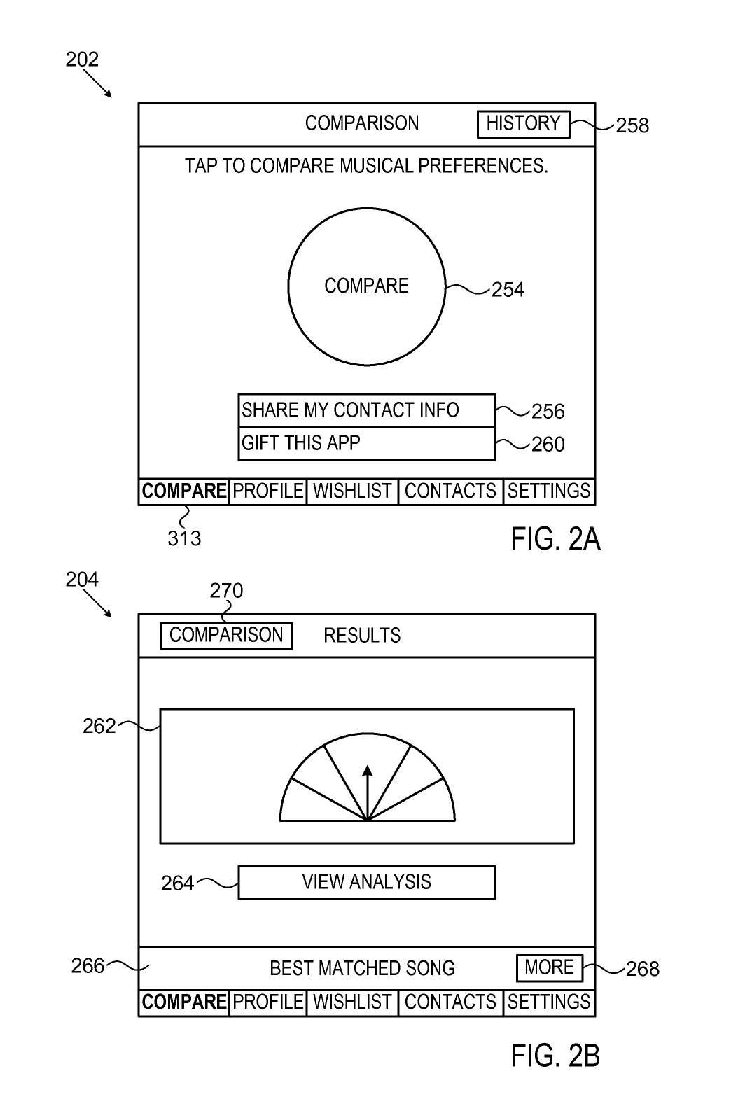

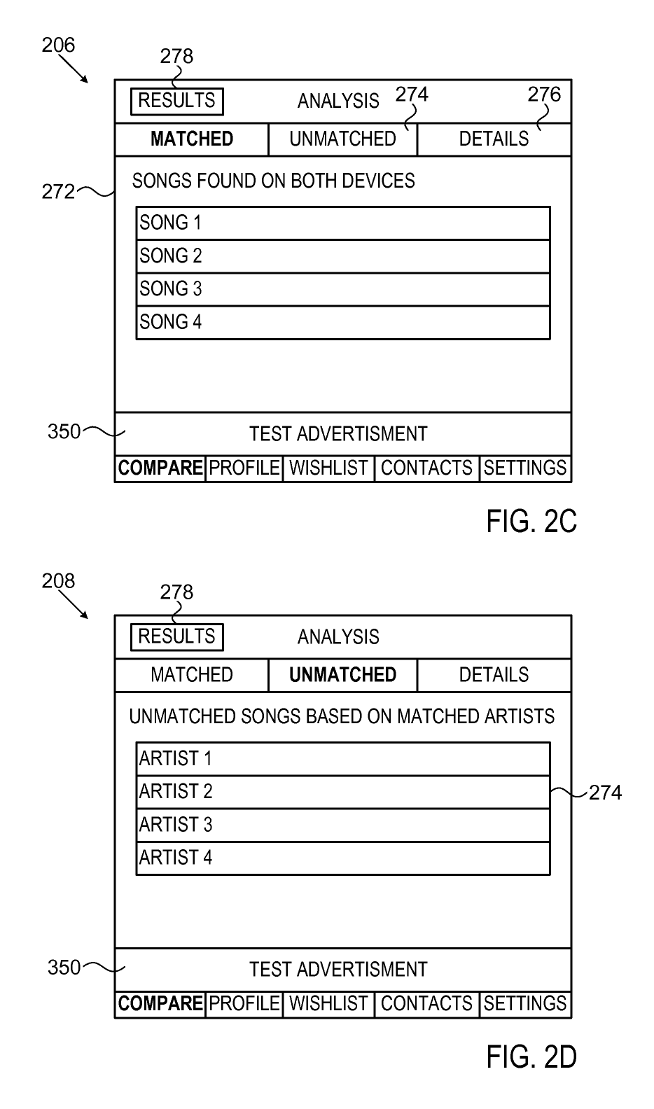

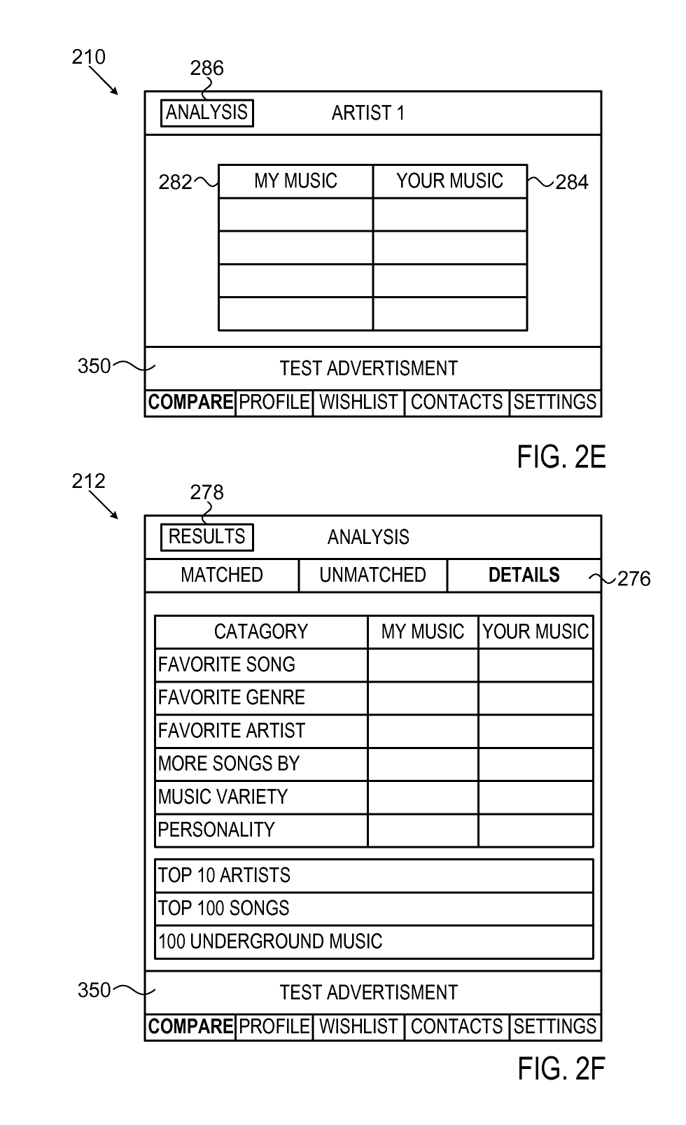

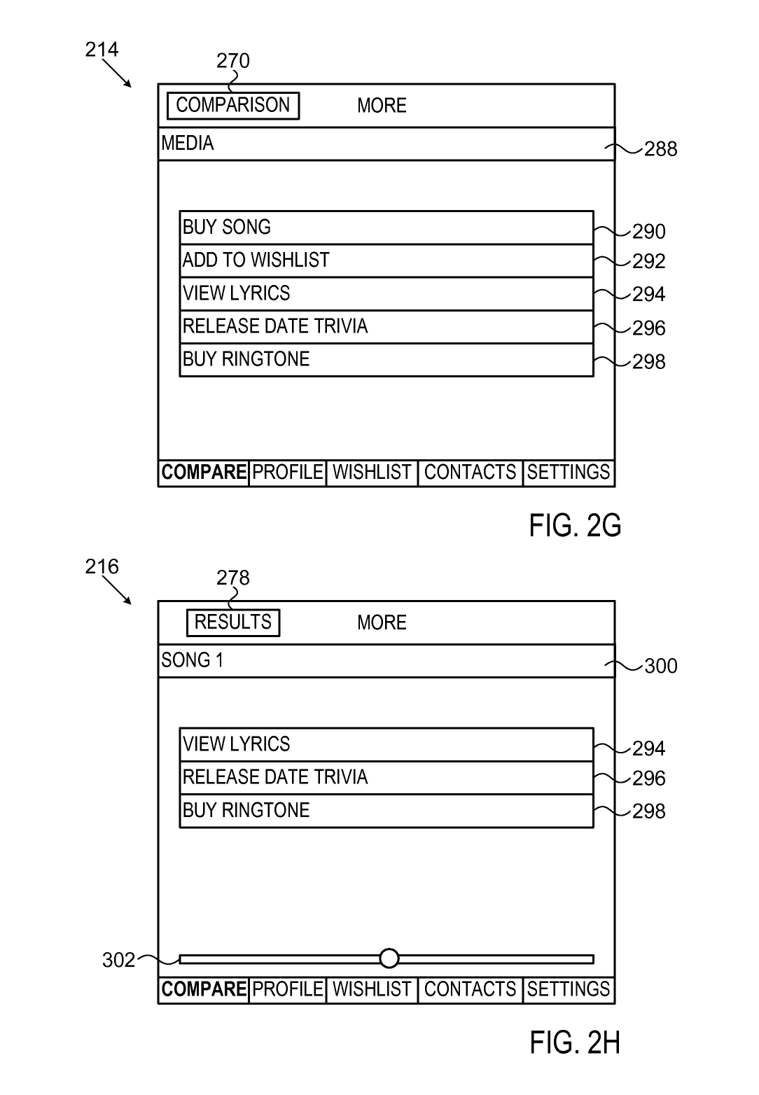

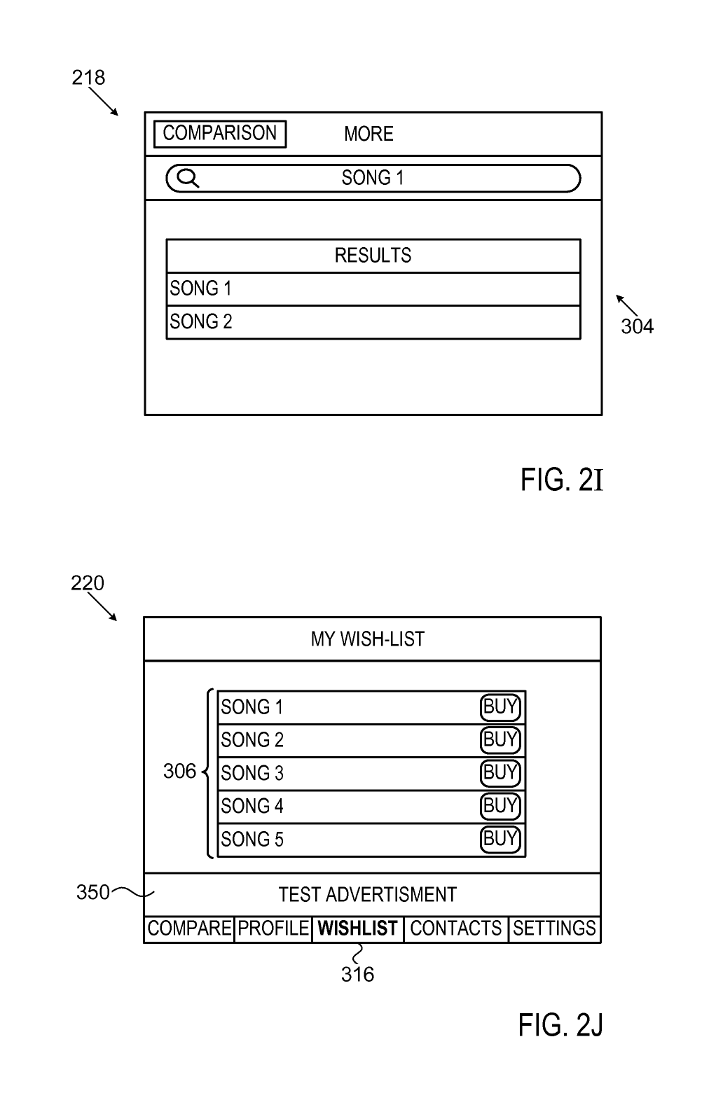

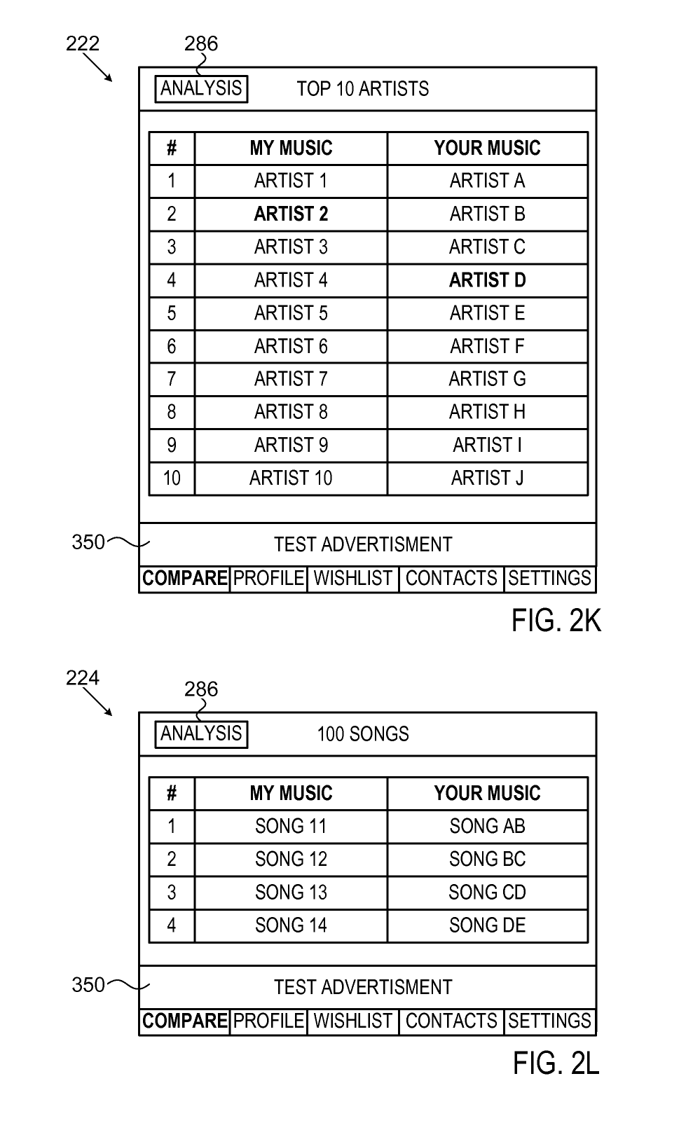

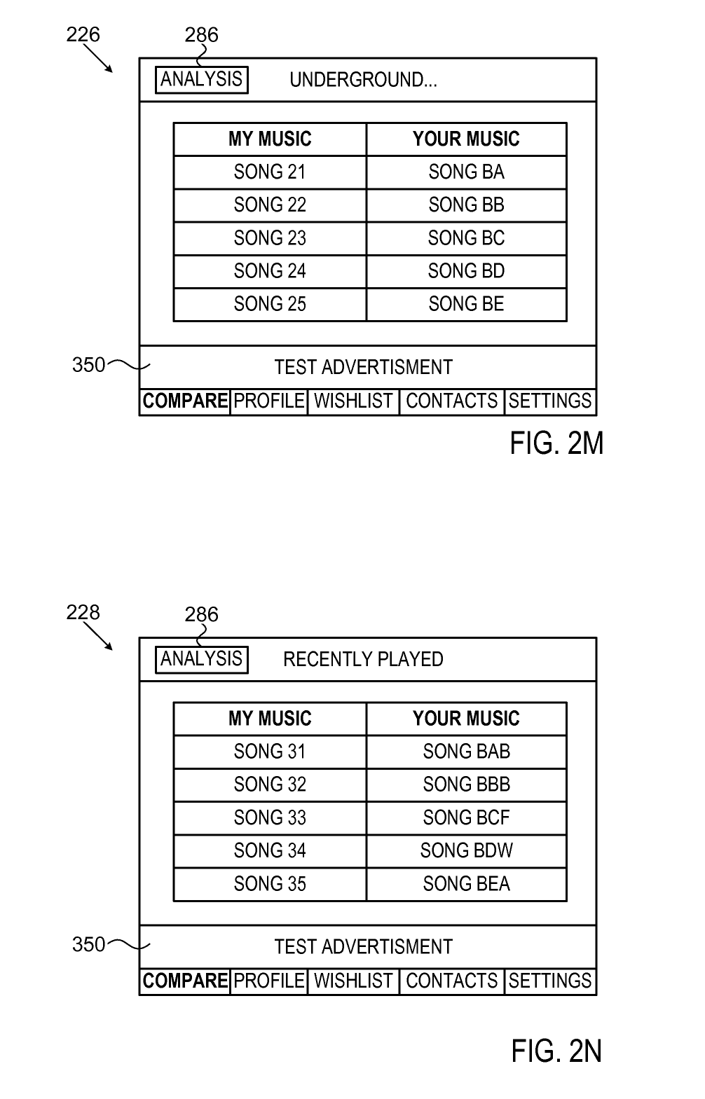

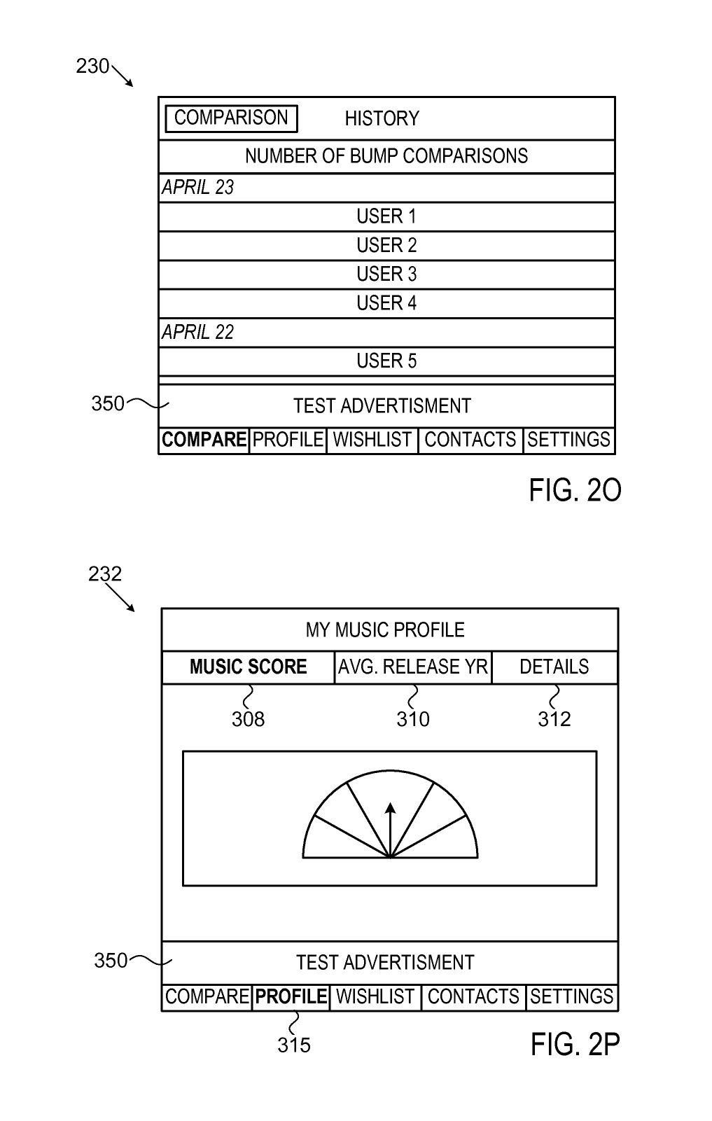

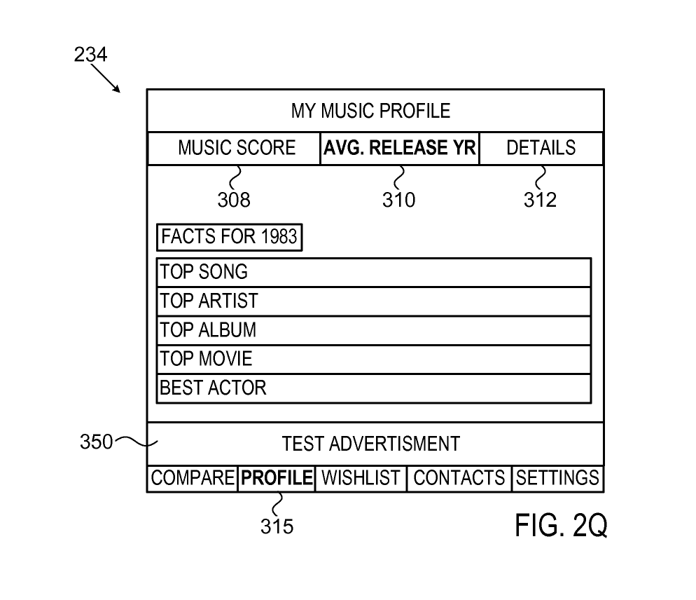

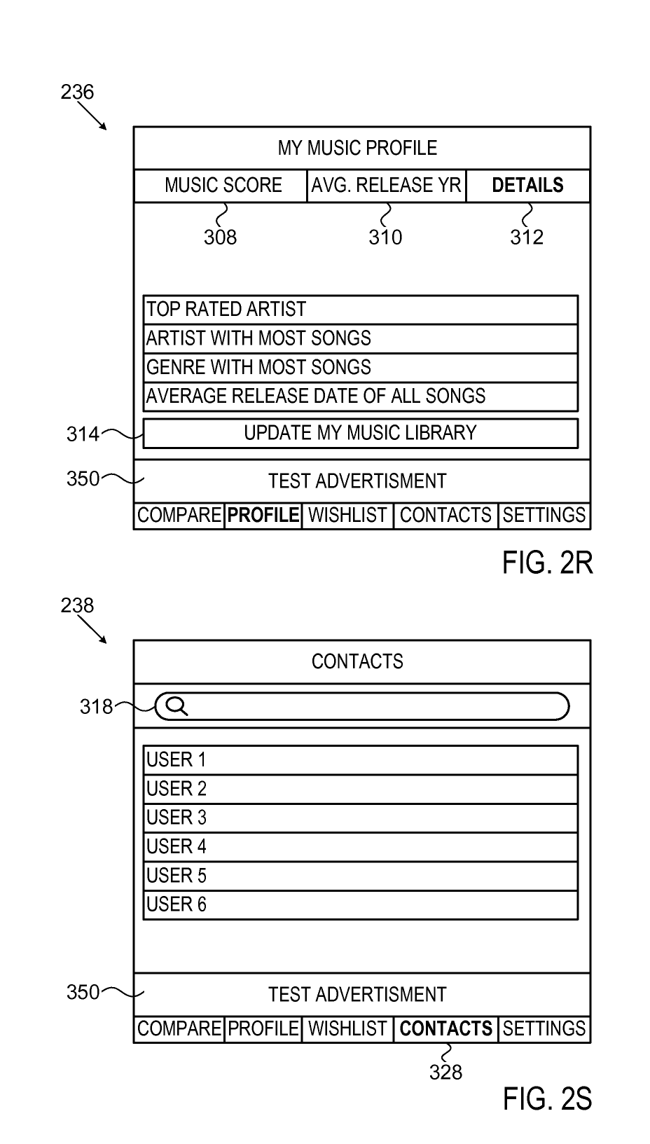

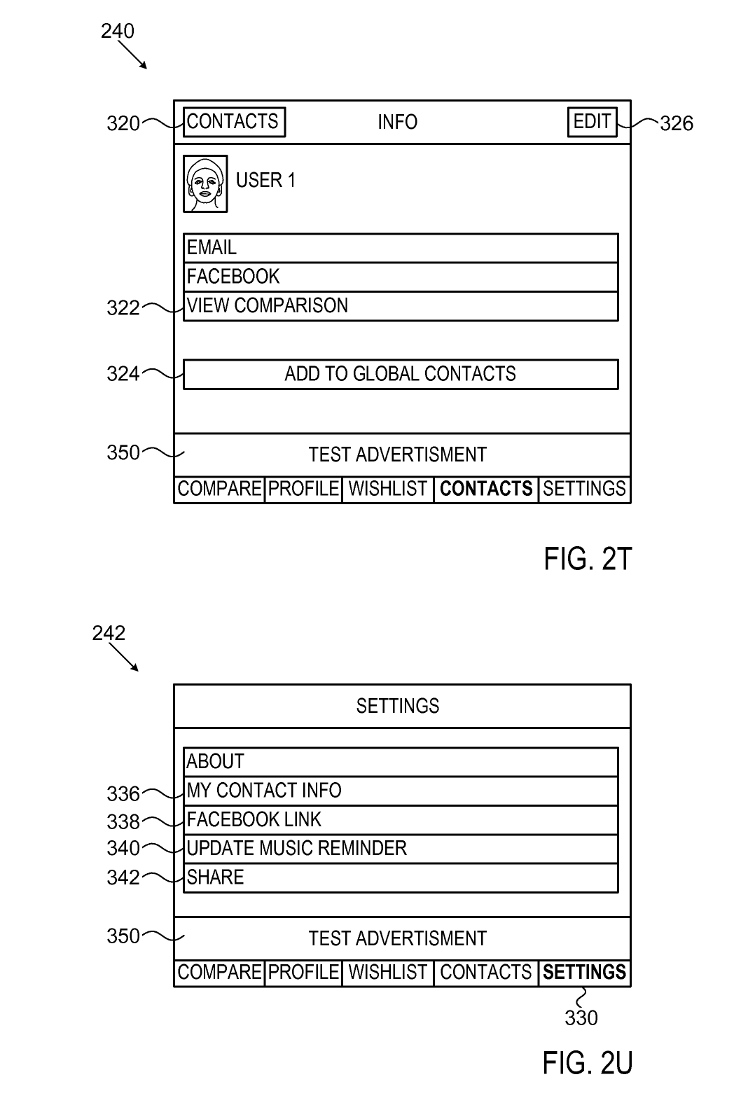

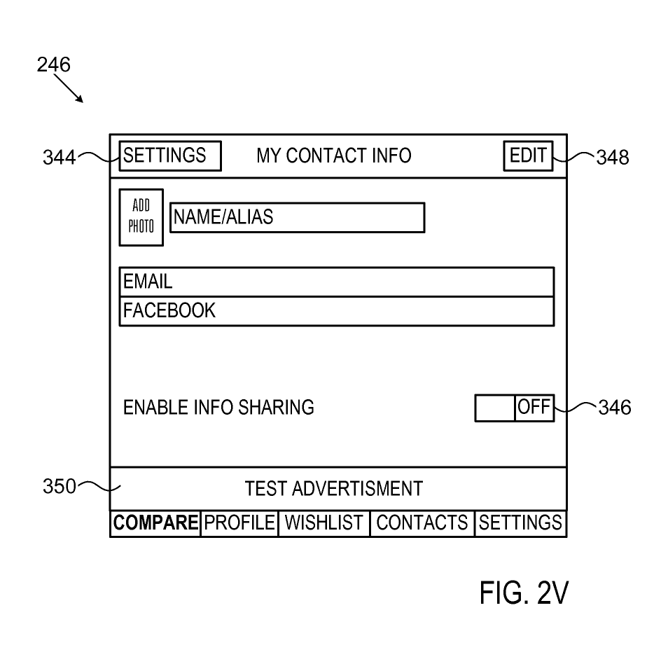

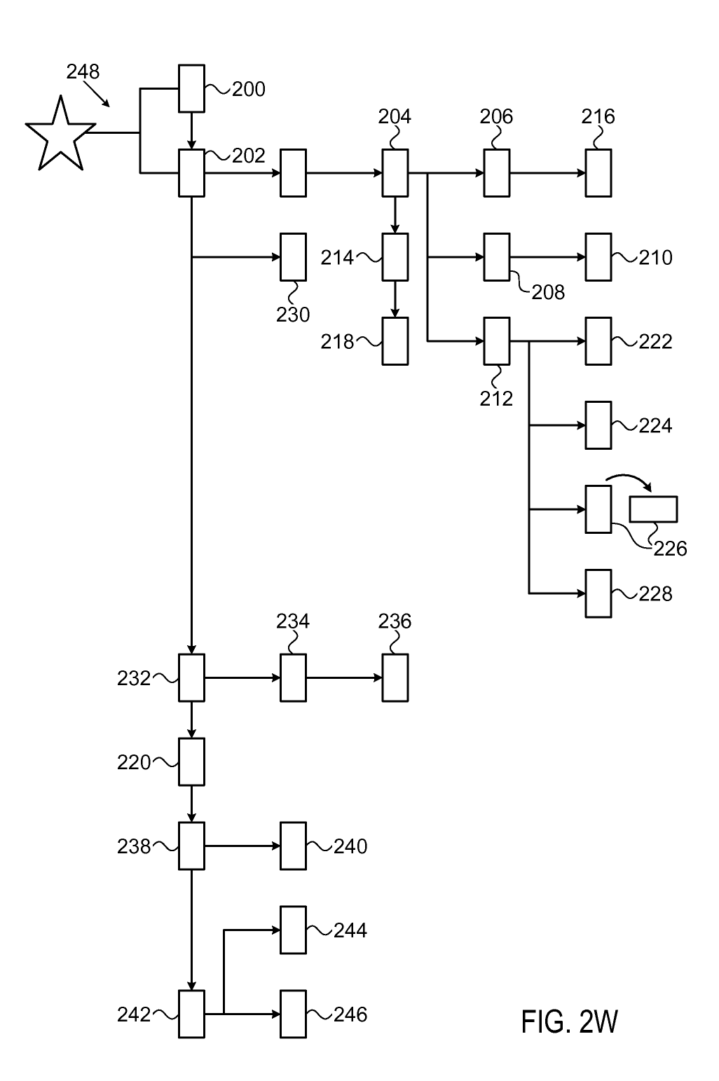

Reference is made to FIGS. 2A-2V, which schematically illustrate user interfaces 200-246 for operating a social media compatibility application in accordance with embodiments of the invention. User interfaces 200-246 may be displayed on a monitor or screen on user devices (e.g., user devices 140 and 150 of FIG. 1), such as, a smart phone or other mobile device. Supporting logic and content for user interfaces 200-246 may be provided by an analysis module (e.g., analysis module 130 of FIG. 1) at a remote server and/or installed locally as an application or plug-in on the user devices.

In FIG. 2A, user interface 202 may include a comparison field 254 to initiate a compatibility test with another other user(s). The other user(s) may be selected, e.g., automatically via a blue-tooth or Wi-Fi connection with a nearby device when the compare button is selected. In a web-enabled version, a user may input another user's user-name or identification to initiate a connection. The compatibility test may run by selecting comparison field 254 or automatically (without selection). User interface 202 may include a privacy field 256 to select whether or not to share the user's personal or contact information (e.g., such as, name, email, account username, etc.). The default position of privacy field 256 may be set to a privacy mode (this may be changed in a user's account settings). In privacy mode, the device may identify the user by an anonymous ID, code or pseudonym. User interface 202 may include a history field 258 to display the user's history of comparisons with other users, for example, listing their names (or anonymous IDs), comparison scores and/or times and dates of comparison. User interface 202 may include a gift field 260 to obtain or purchase the application for another selected user.

In FIG. 2B, user interface 204 may display a compatibility analysis 262 defining results of the comparison (e.g., set in interface 202 of FIG. 2A). Compatibility analysis 262 may include scores, statistical data, graphs, meters or charts defining the compatibility of the current user with the one or more selected users. For example, the compatibility measure may be displayed on a meter, for example, with multiple (5) settings increasing with increased compatibility. User interface 204 may display a list 266 of the most closely matched media items, which may be ordered based on the level of similarity of their usage. List 266 may be expanded or contracted by selecting the list. A user may select field 268 to proceed to user interface 214 of FIG. 2G, for example, to buy, trade, learn and listen to related media. A return to comparison field 270 may be provided for the user to return to user interface 202, for example, to refine the parameters of the current comparison or to imitate a new comparison with a new user. User interface 204 may include a view analysis field 264 which may be selected to proceed to interface 206 of FIG. 2C.

In FIG. 2C, user interface 206 may display an analysis of the comparison including, for example, matched media items 272, unmatched media items 274 (e.g., see FIGS. 2C and 2D), and/or details 276 (e.g., see FIG. 2F) defining the level of similar or dissimilar use for each item. Matched media items 272 may list media detected on both users' devices, for example organized or ranked from highest to lowest usage on both users' devices. A return to results field 270 may be provided for the user to return to user interface 204. A user may select unmatched media items 274 to proceed to interface 208 of FIG. 2D.

In FIG. 2D, user interface 208 may display an analysis of unmatched media items 274 of the comparison. Unmatched media items 274 may list media detected on only one of the user's devices, for example from highest to lowest usage on one of the users' devices.

Matched and unmatched media items 272 and 274 may be listed by song, artist genre, etc. In one example, matched media items 272 may be listed by song, while unmatched media items 272 may be listed by artist, genre or another media category. Each media item (e.g., a song, a video, a podcast) may be assigned to one or more genres. For example, all songs by the Clash may be assigned to the genres of rock and punk; alternately each song by such a group may be individually assigned to one or more genres. To obtain information for the unmatched media items 274 within a media category, a user may select the media category (e.g., Artist=U2) to proceed to interface 210 of FIG. 2E.

In FIG. 2E, user interface 210 may display unmatched media items 274 within the selected media category. Unmatched media items 274 may be divided into a list 282 of music owned exclusively by the current user and a list 284 of music owned exclusively by the other user. Lists 284 and/or 282 may order media items, for example from highest to lowest usage on each respective user's devices. The current user may select an unmatched media item from lists 284 and/or 282 for more information. A return to analysis field 286 may be provided for the user to return to user interface 208 of FIG. 2D.

In FIG. 2F, user interface 212 may display compatibility details 276, for example, such as, both users' favorite songs, genres, artists, music varieties, musical scores, musical personalities, and/or the average of the years their favorite music was created or released. Other or different compatibility details 276 may be used. The user may select any media item for more information.

In FIG. 2G, user interface 214 may provide more information (e.g., via field 268), such as, links and other details related to a selected media item. User interface 214 may provide links, for example, to buy media (e.g., using field 290 to access interface 218), add media to a wish-list (e.g., using field 292), view lyrics (e.g., using field 294), view release date trivia (e.g., using field 296), and buy ringtones (e.g., using field 298) for that media. Fields 290-298 may provide the data locally or, alternatively, may connect the user's web browser to a website to access the data remotely. The media information, such as, song title and artist, may be displayed in field 288.

In FIG. 2H, user interface 216 may provide a media player 300 to play the selected media item (e.g., as a sample or purchased via field 290). The volume of media player 300 may be adjusted using an application-specific volume controller 302 and/or a master device volume controller.

Buy media field 290 may direct the application to user interface 218 of FIG. 2I, where a media distributor (e.g., media servers 110 of FIG. 1, such as iTunes) may sell the selected media items. Interface 218 may be a browser embedded in the application, for example, so that the user does not leave the application to interact with the media distributors. Interface 218 may returned search results 304 matching the selected media item (e.g., listed in field 288).

Wish-list field 292 may direct the application with a wish-list field 316 to user interface 220 of FIG. 2J, where the selected media item may be added to the user's wish-list 306. Wish-list 306 may be compiled from all the selected media into a list, for example, ordered with the most recently added media at the top of the list. Each entry of wish-list 306 may display, for example, a song title, artist, name of the user from which the media is obtained, and the date the media is obtained. A user may select a “buy” field to purchase the media from a media distributor (e.g., using interface 218).

User interface 212 of FIG. 2F may provide analysis of one or more users' media usage, such as, favorite artists (e.g., FIG. 2K), favorite songs (e.g., FIG. 2L), underground music and/or recommendations (e.g., FIG. 2M), and recently played songs (e.g., FIG. 2N), etc.

In FIG. 2K, user interface 222 may provide a detailed list of the other users' favorite artists (e.g., top ten artists) and their songs. Artists used by both users may be highlighted. A user may select to listen to any song (e.g., in interface 216) or view more options (e.g., in interface 214) for an artist.

In FIG. 2L, user interface 224 may provide a detailed list of the other users' favorite media (e.g., top hundred songs). Media used by both users may be highlighted. A user may select to listen to any song (e.g., in interface 216) or view more options (e.g., in interface 214).

In FIG. 2M, user interface 226 may provide a listing of each user's “underground media,” e.g., not readily accessible or for sale from the media distributor. User interface 226 may provide a request to the other user's device to download a selected underground media. Media may be listed in descending order of the users' usage rankings. Both portrait and landscape views of user interface 226 are shown.

In FIG. 2N, user interface 228 may provide a listing each user's recently used, accessed or played media. A user may select to access any of the recently played media (e.g., in interface 216) or view more options (e.g., in interface 214).

History field 258 of FIG. 2A may direct the application to user interface 230 of FIG. 2O, which display the user's history of comparisons with other users. User interface 230 may list, for example, the other users' names (or anonymous descriptions such as “unknown” or ID codes), comparison scores and/or times and dates of comparison. A user may select any of the users' in the list to view a results or analysis interface 204-212 for a comparison with that user.

In FIG. 2P, a profile tab 315 may direct the application to user interface 232 providing a media profile for the user. The media profile may, for example, define the user's “musical score” 308, personality type or media proficiency level, for example, based on the user's recorded media usage. For example, musical score 308 may be computed based on a number of songs, artists, and/or genres in the user's music library, songs most played by the user and whether or not the user rates music. In one example, musical score 308 may be displayed on a meter, for example, with multiple (5) settings increasing with increased media proficiency. In another example, each proficiency level may be assigned a class, such as, an “advanced” or “savant” proficiency level for users that access diverse styles of media and a “novice” proficiency level for users that access a narrow range of media styles.

In addition or alternatively, user interface 232 may assign the user a personality type. The personality type may also be assigned based on the user's recorded media usage, for example, the user's most prevalent genre, the average of the release years of the media, etc. For example, users with more modern taste may be assigned a “rock and roll” or “young” personality type, while users with more classic taste may be assigned an “old fogie” personality type. A unique graphical avatar or image may be displayed for each user to depict their music personality. A user may select an average release year field 310 to proceed to interface 234 of FIG. 2Q or a details field 310 to proceed to interface 236 of FIG. 2R.

In FIG. 2Q, user interface 234 may display field 310 defining the average release year of the user's musical library. User interface 232 may also display trivia related to that year, such as, top song, top artist, top album, top movie, best actor for that year, etc.

In FIG. 2R, user interface 236 may display details 312 defining a statistical analysis of the user's media usage. Details 312 may list all the components that define the user's musical profile. A user may select a details 312 entry to obtain more information. A user may select to an update field 314 to update the user's musical profile with any changes to the user's music library and usage. A progress bar may be displayed as the update progresses.

In FIG. 2S, a contacts tab 328 may direct the application to user interface 238, which displays the user's contacts. Users may share contact information and perform a comparison with the user identified by their contact (e.g., if the user enables an information sharing mode). In one example, a user may scroll through the contact list by swiping a touch screen (e.g., vertically) or by using an index bar. The user may search the contacts by entering a name, personality type, compatibility ranking, etc., in search field 318. A user may select a contact to obtain more contact information to proceed to interface 240 of FIG. 2T.

In FIG. 2T, user interface 240 may display a detailed description of another user's contact information. The detailed description may include, for example, a user's picture, name, email, username for this or other networking applications, such as, Facebook, Twitter and LinkedIn, etc. An edit field 322 may enable the user to edit the contact information. A view comparison field 322 may enable the user to view the results of the comparison test with the contact user. A global contacts field 324 may enable the user to add the current contact to another global contact list, such as, an address book, in the user's device. A return to contacts field 320 may be provided for the user to return to user interface 238. It may be appreciated that some contacts may have blank or anonymous contact information, for example, in accordance with their privacy settings.

In FIG. 2U, a setting tab 330 may direct the application to user interface 242 may display the application settings including, for example, a my contact field 336 to proceed to interface 246 of FIG. 2V, a social media link 338 to link the compatibility application to another social networking application, an update media reminder field 340 to turn on or off automatic updates to the user's database of the media library or player content, and a share field 342 to switch between a share information mode and a hide information mode to share or hide personal contact information (e.g., default may be set to hide).

In FIG. 2V, user interface 246 may display the current user's contact information. The contact fields in user interface 246 may be initially empty and the user may select an edit field 348 to enter and edit the user information. The contact fields may include, for example, the user's picture, name, email, username for networking applications, such as, Facebook, Twitter and LinkedIn, etc., a share information field 346 to set share field 342 of FIG. 2U to share the user's contact information with other users, e.g., automatically when the user devices are compared.

Reference is made to FIG. 2W, which schematically illustrates an application map 248 showing the interrelations between user interfaces 200-246 of FIGS. 2A-2V in accordance with embodiments of the invention. Arrows in application map 248 show one sequence or order in which user interfaces 200-246 may be displayed, although any other order of interfaces 200-246 may be used.

In some embodiments, one or more interfaces 200-246 may display advertisements 350. The user device may receive advertisements 350 from one or more remote advertising servers and the application may embed advertisements 350 into pre-designated areas of interfaces 200-246, for example, via an advertisement API. Advertisements 350 may include text banners, images, video, pop-up windows, etc. Advertisements 350 may be generic or targeted to the media tastes selected by the user.

Although FIGS. 2A-2W depict examples related to music media, any other media may similarly be used. For example, for literature, artist may be replaced with author or editor and song may be replaced with book, shorts story, essay or poem; for movies or television, artist may be replaced with director or actors and song may be replaced with film or television show.

Embodiments of the invention may “scan” and analyze media or media metadata stored in or played on a user device, for example, to compute information recording the usage of media by the user of the user devices including one or more of the following (other or additional features may be used):
Total number of media items (e.g., songs, videos, e-books, etc.).
Total number of different artists (e.g., musicians, directors/actors, writers, etc.).
Total number of different genres (e.g., in music, film, television, literature, etc.).
Genre with most media items.
Artist with the most media (e.g., stored as a percentage (%) of total media and/or absolute value).
Artist with the most media played (e.g., stored as a percentage (%) of total media and/or absolute value).
Genre with the highest percentage of media (e.g., stored as a percentage of total media and/or absolute value).
Favorite artist (e.g., artists with the highest average rating, where the average rating for each artist is the sum of the rankings or scores for all media items by the artist, divided by number of media items for that artist). Average ratings may be stored for artists with the top ten, hundred, etc., rating values. Ratings may be entered manually by a user or computed automatically by a processor inferring ratings based on media usage.
Most played media items (e.g., top ten, hundred or any other number).
Most played artists (e.g., top ten, hundred or any other number).
Favorite media items (e.g., top ten, hundred or any other number).
The number of media items found in a hits list, such as, the Billboard top 40 list.
Most played media items excluding media items found in the hits list.
Most skipped media items (e.g., ten, hundred or any other number).
Most recently played media items (e.g., ten, hundred or any other number).
The average release date or year of all media items stored and/or played. A “media age rating” may also be assigned that is associated with the average release date or year. The average release date and/or the rating may be displayed to the user. The date may be used as an input to the compatibility test as well as a trivia tool, for example, that lists facts or trivia associated with that year (e.g., as shown in user interface 234 of FIG. 2Q). Trivia associated with a year may include, for example, a top Music Artist, top song, top movie, best actor, best actress, top television comedy, top television drama, most popular toy or product, etc., for that year. Trivia data for each year may be stored or embedded in the application itself or, alternatively, may be retrieved from a media server. Trivia data may be stored, for example, for the past 50-100 years.

These media usage parameters may be captured from the media metadata and may be stored associated with the user's profile, for example, to be used for computing the user's musical score and the user's compatibility with other users. These parameters may include no user input (e.g., except for favorite artist, when it is manually entered).

In some embodiments, user generated input may be accepted and may be used, for example, separately or together with non-user generated input parameters, to compute the user's compatibility with other users. Some embodiments may combine user and non-user (computer-generated) input to determine compatibility. Other embodiments may provide two separate compatibility tests, for example, one based exclusively on computer-generated (non-user generated) input and the other based on user-generated input.

Users may view their own profiles (e.g., by selecting profile field 315 of FIG. 2P). A user profile may include one or more of the following parameters (other or additional parameters may be used):
Favorite artists, e.g., listed in order (top ten, hundred or any other number).
Favorite genre.
Pie chart display of genre tastes, e.g., each pie chart portion defined by the percentage of the media items belonging to the genre in the user's entire media library.
Musical score, e.g., determined by a number of media items on the user's device, number of different artists on the user's device, as compared to default values or average of actual users (e.g., obtained via market analysis).
Most played media items, e.g., listed in order (top ten, hundred or any other number).
Music age rating, e.g., based on the average date of all the media released.
   These user profile parameters may be transmitted to other users when the users perform a comparison with (e.g., or “pound”) their devices. The application may periodically prompt users to update their profiles (or decline).

In some embodiments of the invention, to generate a more targeted compatibility test, users may enter one or more of the following parameters to limit their compatibility matches (other or additional parameters may be used):
Sexual Orientation (e.g., provided in “friend finder” mode):
   M looking for F
   F looking for M
   F looking for F
   M looking for M
   Friendship Only
   Don't care.
Age range of prospective match (e.g., provided in “friend finder” mode):
   Any age
   Teenager
   Adult
   18-21
   21-30
   30-40
   40-50
   50 plus.
Disposition/coping style (e.g., high-stress vs. calm).
Interests and hobbies (e.g., sports, fashion, etc.).
Family values (e.g., family is very important vs. not important).
Religious affiliation.
Personality (e.g., outgoing vs. shy).
Communication (e.g., open with feelings vs. private)
Romantic availability (e.g., single vs. married)
Desired relationship:
   Conversation only
   Friends
   Dating
   Sexual encounters
   Casual relationship
   Boyfriend/Girlfriend
   Committed relationship
      These parameters may be confidential or may be shared with other users, for example, according to their privacy settings.

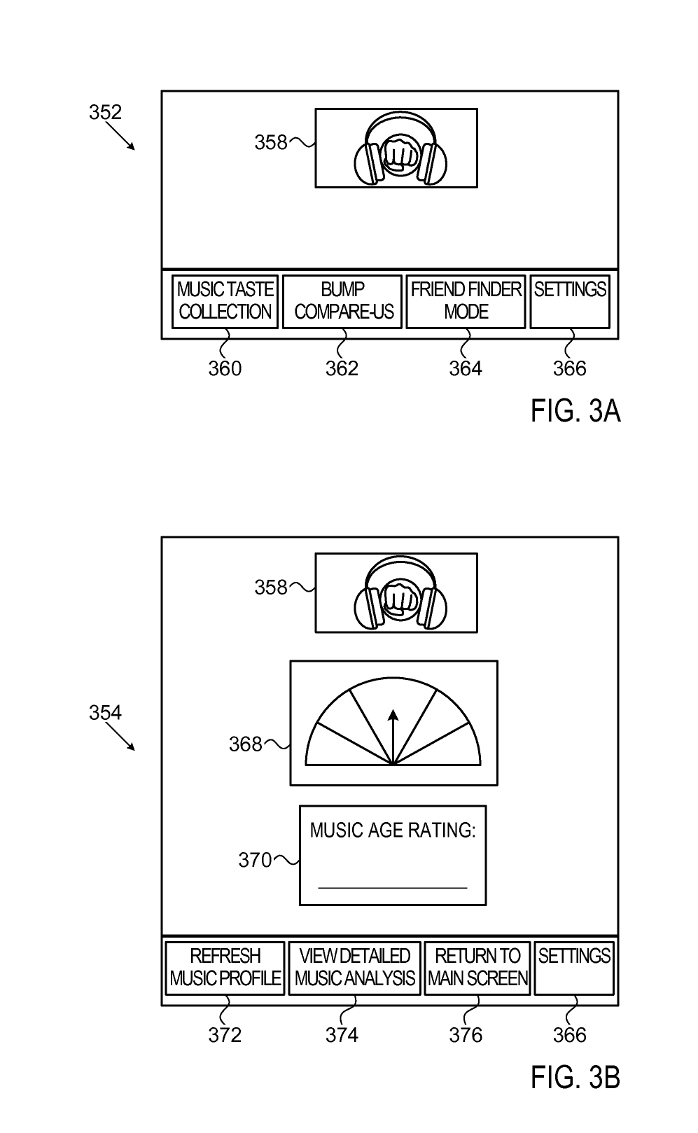

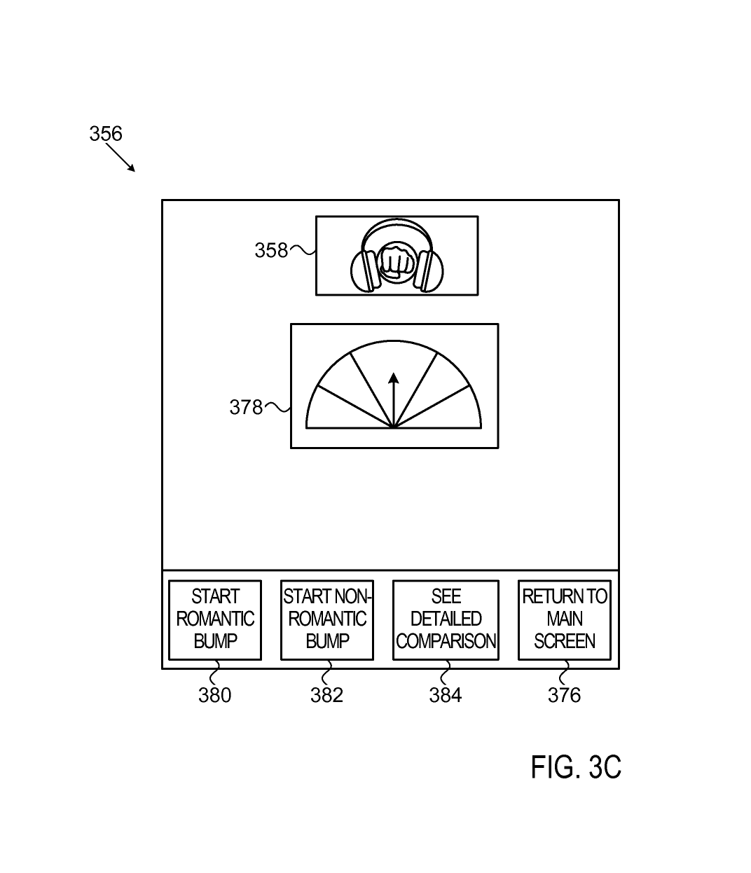

Reference is made to FIGS. 3A-3C, which schematically illustrate other examples of user interfaces 352-356 for operating a social media compatibility application in accordance with embodiments of the invention.

User interfaces 352-356 may include a background 358 or “skin,” which may be a default application design, or alternatively, may change dynamically to reflect the user's individual data, such as, the user's compatibility results with other users, the user's musical personality, an image of the user's favorite artist or album cover, etc. The application data may be displayed over background 358.

In FIG. 3A, user interface 352 may display the results of data collection and analysis in a user's profile, e.g., including favorite artists, favorite genre, musical score, etc. During data collection, the application may record or track the user device's usage of media from the device's media library, for example streamed online or played in a media player. These media usage parameters may be used to perform a comparison test at a later time. The media usage parameters may be stored and time stamped, for example, for high-speed retrieval at later times and/or to periodically remind the user to update their profile data. User interface 352 may include a media taste collection field 360 to direct the application to user interface 354 of FIG. 3B, a “compare-us” field 362 to direct the application to user interface 356 of FIG. 3C, a “friend-finder” field 364 and a settings field 366.

Friend-finder field 364 may initiate a geo-location module to locate other users running the same compatibility application. The geo-location module may include code to upload a profile and location to a server (e.g., for remote geo-location) and/or the code to utilize a personal area network or blue-tooth connection to locate nearby users (e.g., for local geo-location). User interface 352 may display located users and their locations and may allow users to select a located user and send them a message to initiate a conversation. Conversations may be anonymous, e.g., in accordance with the users privacy settings. Each user may activate or deactivate permission to receive incoming conversation messages at any time.

In FIG. 3B, user interface 354 may display a media profile for the user. The media profile may define the user's musical score 368, e.g., on a meter, and/or the user's music age rating 370, based on the data collection of the user's recorded media usage. User interface 354 may include a refresh field 372 to collect data to update or refresh the user's musical profile (e.g., a time estimate or progress bar may be displayed during collection). User interface 354 may include a view analysis field 374 (e.g., view analysis field 264 of FIG. 2B) to direct the application to an analysis interface (e.g., interface 206 of FIG. 2C). The analysis process may run in parallel with other device processes, for example, allowing the application to simultaneously perform other functions. User interface 354 may also include a return to main screen or “home” field 376 to return to interface 352 and settings field 366.

In FIG. 3C, user interface 356 may display results 378 of a compatibility test, e.g., triggered by selecting compare-us field 362. Results 378 may be displayed, for example, as a gauge, meter rating scale and/or score, to indicate a degree of compatibility between for example two users. The type of compatibility test and/or results 378 display may depend on a type of relationship (e.g., “romantic” or “non-romantic”) and may be selected by the user, e.g., using romantic bump field 380 or non-romantic bump field 382. In one example, when romantic bump field 380 is selected, results 378 meter may rank compatibility in categories vary from “just friends” (incompatible) to “love birds” (compatible). In another example, when non-romantic bump field 382 is selected, results 378 meter may rank compatibility in categories vary from “nothing in common” (incompatible) to “separated at birth” (compatible). A user may switch between romantic and non-romantic modes by toggling between fields 380 and 382. In other embodiments, more than two different relationships may be provided (e.g., for “friends,” “co-workers,” “casual dating,” “serious commitment,” etc.) or, alternatively, a single compatibility test may be used for all users. Other compatibility measures, such as for example a numerical rating (e.g., 0-10) may be used.

User interface 356 may also include a detailed comparison field 384, which may trigger interface 356 to display media usage and/or profile parameters input into the comparison test for one or both of the users. In one example, each user's information may be displayed in a different one of a dual bar graph or other display.

Settings field 366 in FIGS. 3A and 3B may control the one or more of the following application settings (other or additional application settings may be used):
Enable the transfer of contact information. The setting may be yes or no with default set to no.
Enable a “refresh reminder” feature. The setting may be yes or no with default set to yes. This setting may cause the application to prompt the user to refresh their profile after the application is started and/or periodically (e.g., every 30 days).
Enable a checkbox to indicate whether the user maintains a favorite and a ratings field for the user to enter ratings for their media. The favorite checkbox setting may be yes or no with default set to no.
Enable anonymous profile upload to server. The setting may be yes or no with default set to no.
Enable geo-location or “friend finder” feature. The setting may be yes or no with default set to no.
Enter an anonymous name to be transmitted to another user when the geo-location feature is enabled.
Enter personal data fields. Personal data fields may be transmitted upon transferring a contact. Personal data fields may be filled in manually or imported from global fields, e.g., from a local memory or server memory. Personal data fields may include one or more of the following (other or additional information may be used):
   Name.
   Age.
   Phone Number.
   Email address.
   Facebook username.
   Twitter username.
   Linked In username.
   Picture.

FIGS. 3A-3C may use dynamic graphics to load the screen display while the application loads, collects data and waits to receive data from a comparison transfer.

The application may execute one or more of the following operations (other or additional operations may be used):

1. Metadata collection.

2. Musical score calculation.

3. Media personality determination.

4. Average release date/year determination.

5. Media age determination.

6. Offbeat or underground taste determination.

7. Compatibility test calculation.

8. Data display (e.g., for user profile and/or compatibility test).

9. Share profile and comparison results with server and/or other users.

10. Embed advertisement displays.

For metadata collection, media data or metadata may be collected. Metadata may be collected once, e.g., when the program is installed, or multiple times, e.g., periodically prompted by a “reminder” message that may indicate the “age” of the media or the last refresh date. Depending on the media library size, metadata collection may take a significant amount of time (e.g., 10 minutes-10 hours). In some embodiments, only the initial collection scans the entire media library, after which each subsequent update may scan only media metadata with a date modified field indicating the media was last modified after the previous update. In some embodiments, a progress bar or time based indicator may be displayed to indicate that the application is busy collecting data. In other embodiments, the metadata collection process may run in parallel with other device processes, for example, allowing the application to simultaneously perform other functions. Once the data is collected and analyzed, the results may be displayed as the user's profile (e.g., in interface 232 of FIG. 2P and/or interface 354 of FIG. 3B).

For the musical score calculation, the application may generate a value or category describing the user's media proficiency or expertise. The musical value or score may, for example, range from 0 to 180 displayed on a graph by an angle from 0 to 180 degrees as shown in FIG. 3B, although any other numbers or scales may be used. The graph may be divided into multiple (e.g., 5) categorical segments, for example, according to the following relationships:
Segment 1: Score range: 0-36: Category: “Groupie.”
Segment 2: Score range: 37-72: Category: “DJ
Segment 3: Score range: 73-109: Category: “Music Executive.”
Segment 4: Score range: 110-146: Category: “Music Mogul.”
Segment 5: Score range: 146-180: Category: “Hall of Fame.”
   The following is an example of commands, which when executed by a process or processor, calculates the musical score. The musical score calculation may be executed for example, by the “musical score” command according to the following formula (other formulas may be used):
   Musical score=song count score+number of artists score+number of normalized genres score+music variety score+top 40 songs score+bonus for most played song+bonus for rating songs. The music score may be computed by a processor (e.g., processor 136 of FIG. 1, or locally on a user device).

The song count score may be a normalized value range containing the total number of songs on (e.g. stored on, or in an index) the user's device. The normalized ratio of the number of songs to the song count score may be, for example, as follows:
0-100:5
101-500:10
501-1000:20
1001-2000:30
2001 or more:36

The number of artists score may be a normalized value range containing the total number of unique artists on (e.g. stored on, or in an index) the user's device. The normalized ratio of the number of artists to the number of artists score may be, for example, as follows:
0-10:5
11-50:10
51-100:20
101-200:30
201 or more:36

The number of normalized genres score may be a normalized value range containing the total number of unique genres on the user's device. The number of unique genres on the user's device may be determined by classifying each genre into one of a plurality of (e.g., 12) preset genres. The number or index of each preset genre may be multiplied by a scalar value (e.g., 3). This product may be the number of normalized genres score (e.g., which may range from 3-36). Other numbers of genres and scalar values may be used.

The music variety score may measure the variety of genres played on each user's device. The music variety score may be computed by dividing the number of unique genre's on the user's device by a number of recognized or available genres (e.g., N=112) to figure out what percentage of genres the user has (when used herein, a user “has” a song, genre, artist, etc., when the user stores the song, a song in the genre, a song by the artist, etc., on a user device, the user has the song indexed on the device, or the user has accessed the song; other media such as videos may be referred to similarly). The music variety score may range from, e.g., 0-100% and may be capped at 100%. The percentage may be multiplied by a scalar value, such as, the maximum normalized genres score (e.g., 36). For example, the music variety score=59%*36=21 when the number of unique genres=66 and percentage=66/112=59% and the music variety score=100%*36=36 when the number of unique genres=169 and percentage=169/112=100%.

The top 40 songs score may be a normalized score defining a percentage range containing the percentage of the user's songs (a user's songs may be the songs e.g. stored on, or in an index, on the user device) that are not on a popular music list or database, such as, a Billboard™ top 40 charts. The ratio of the percentage range to the top 40 songs score may be, for example, as follows:
0%-24%:0
25%-49%:10
50%-74%:20
75%-100%:30
   Each song may be checked on a list for the song's release year or one or more consecutive years. If a song is released in a current year (e.g., and no top 40 chart data is available), the song may be considered to be on the top 40 chart.

The bonus for most played song may be added to the musical score if the user's most played song is not on the top 40 charts. The bonus for most played song may be a predetermined number (such as, 20).

The bonus for rating songs may be added to the musical score if the user rates songs or a predetermined number or percentage of their total songs. The bonus for rating songs may be normalized from a percentage range containing the percentage of the user's songs that have been rated, for example, as follows:
0%-5%:0
6%-10%:10
11%-100%:20

The musical score may be displayed, for example, as a segment of a meter with multiple (5) or (8) segments. Other methods of displaying may be used. The musical segment=musical score/the total number of segments. The user's maximum possible segments may be determined based on the total number of songs they have on their device. In one example, when there are 8 segments, if the user has (e.g. stored on, or in an index on a user device) less than 100 songs then their maximum quadrant may be, for example, 1 and if the user has less than 1500 songs, then their maximum quadrant may be, for example, 7.

Other or additional terms, scores, ranges, normalizations, percentages, scalar values, segments or types of displays may also be used to compute the musical rating or score.

To determine the user's media personality, the application may analyze the user's media usage. In one example, genres may be associated with personality categories and the user may be assigned a personality category associated with their favorite genre, most played genre, genre or their top media items, etc. In some embodiments, there may be more genres than personalities so multiple genres may be grouped or associated with each of one or more personalities. For example, the classic rock” and “rock” genres may be correlated with a single “rock” personality category). In other embodiments, there may be more personality types than genres so multiple personality types may be grouped or associated with each of one or more genres. Some embodiments of the invention may generate personalities according to a theme (e.g., defined by the application). For example if the theme is animal based, one user may be assigned a “falcon” personality type, while another user may be assigned a “rat” personality type. In another example using an astrology theme, one user may be assigned a “Virgo” personality type, while another user may be assigned a “Capricorn” personality type. Users may select to be matched with other users of the same or different personality types.

To determine the average release year, the application may compute the average of the release dates associated with all media items stored and/or played (e.g., over the entire device lifetime or within one or more predetermined time periods). The date may be used as an input to the compatibility test as well as a trivia tool, for example, providing facts or trivia associated with that year. For example, if the average release year is 1999, the application may list the number one song for that year, the most popular television show or movie, the president, etc., for that year.

To determine the user's media age, the application may assign an age to the user associated with the average release date or year.

To determine the user's offbeat or underground tastes, the application may analyze media that does not register on popular media charts, websites and/or databases.

To execute the compatibility test calculation for two users, the application may input user media usage information, user profile information, additional personal information for targeting the compatibility results and/or analyzed ratings or other data for the users. The compatibility test may be initiated, for example, by selecting a field (e.g., compare-us field 362 of FIG. 3A) or automatically without any user input (e.g., for users with above threshold compatibility or that are located nearby in a geo-location mode). The compatibility test may compare the recorded media usage for the users and, for example, using a linear, best-fit or root mean square function, to compute a measure of compatibility for the users. The results of the compatibility test may be displayed (e.g., as results 378 of FIG. 3C), for example, as well as information about the other user, such as, statistics, facts or talking points to compare tastes and encourage the users to communicate. User information may include, for example:
Favorite media items that the users don't have in common, e.g., “unmatched media.” The users may be prompted to purchase media they don't own that is enjoyed by the other user.
Media age and trivia for the other user.
Underground media owned by the other user.
Interesting or unusual media indicating a personality trait for the other user, for example, if the user has certain combinations of songs such as, from the album “The Wall”, “Lucy in the Sky with Diamonds”, etc.
If the user excluded certain “embarrassing” media from the compatibility test.
Personality types or themes calculated for the other user.
Suggested media or relevant material sales (also available in a single user mode). A “more” button may direct the user to a media distributor to purchase the suggested media.

The following is an example of computations, which when executed by a process or processor, calculates the compatibility rating or score (other or additional computations may be used).

Comparison score=+genre score+matched artists score+musical quadrants score+release year score+matched songs score. In one example, the comparison score may range from 1-100 (other ranges may be used, and other measures or rating scales). The comparison score may be computed by comparing the users' recorded media usage information, such as, genre score, matched artists score, etc. A measure of compatibility between the two or more users (e.g., a rating, quadrant category, such as, “separated at birth,” or the compatibility score itself) may be determined based on the comparison. The comparison, computation of the score and compatibility determination may be computed by a processor (e.g., processor 136 of FIG. 1).

The genre score may be added to the comparison score. A maximum genre score (such as, 30) may be added to the comparison score if the users being compared have matching favorite non-normalized genres or matching favorite normalized genres for their stored and/or played media. Otherwise, the genre score may be a percentage of normalized genres that each user has in common with another user. The maximum of these percentages may be multiplied by a scalar value (e.g., 30) to generate the genre score. For example, if user A has genres rock, dance, pop, urban, and other, and user B has genres, other, dance pop, urban, classical, and jazz, then the ratio of the number of genres that user A has in common with user B to the total number of genres on user A's device is 4/5 (80%) and the ratio of the number of genres that user B has in common with user A to the total number of genres on user B's device is 4/6 (67%). Therefore, the genre score will be the maximum of 80% and 67% multiplied by 30: (80%, 67%)*30=24.

The matched artists score may be added to the comparison score. A maximum matched artists score (such as, 30) may be added to the comparison score if the users have matching favorite artists, for example, that are the most played or highest ranked artists. Otherwise, the matched artists score may be the number of matching artists in their top 10 lists multiplied by a scalar value (e.g., 3).

The musical quadrants score may be the difference in the users' musical score segments subtracted from the total number of segments. The score is typically greater than or equal to 0.

The release year score may be the difference in the users' average release years for stored and/or played media, for example, multiplied by a scalar value (e.g., 0.5) and subtracted by a scalar value (e.g., 5). The score is typically greater than or equal to 0.

The matched songs score may be a normalized value range containing the number of played or stored songs matched for each user. The normalized ratio of the number of matched songs to the matched songs score may be, for example, as follows:
0-10: 5
11-15: 15
16-20: 20
21-25: 25
26 or more:30
   In one example, user A may have 100 songs and 10% of them may be considered matched and user B may have 100 songs and 19% of them may be considered matched. Therefore, the matched songs score may be the maximum of 10% and 19%: (10%, 19%)=19%, so the matched songs score is 20.

Other or additional terms, scores, ranges, normalizations, percentages, scalar values, segments or types of displays may also be used to compute the compatibility rating or score.

When the compatibility score calculation is complete, the user devices may automatically queue matching media, for example, according to the following order:
The highest matching media item in the underground music list (joint favorite media item not found in a popular media database).
The highest matching media item (e.g., even if it is found in the popular media database).
The highest rated unmatched media item from the top matched artist.

The results of the compatibility test may be scored, for example, in a range from 0 to 180 and may be displayed on a graph by an angle from 0 to 180 degrees as shown in FIG. 3C, although any other numbers or scales may be used. The graph may be divided into multiple (e.g., 5) categorical segments, for example, according to the following relationships:
Segment 1: Score range: 0-36: Category: “Mortal Enemies.”
Segment 2: Score range: 37-72: Category: “Lost in Space.”
Segment 3: Score range: 73-109: Category: “Borrow your car.”
Segment 4: Score range: 110-146: Category: “Drink from your Milk Carton.”
Segment 5: Score range: 146-180: Category: “Separated at Birth.”

If the user enables data sharing, one or more of the following parameters may be transmitted to a server (e.g., server 130 of FIG. 1) and stored (e.g., in memory unit 138 of FIG. 1). Other or additional parameters may be transmitted.

User profile items:
Unique ID for the user from the device identifier.
Version of the application.
Timestamp.
Email address of the user, e.g., to contact them for promotions.
Musical score or rating (e.g., 0-180 score).
Average media release year.
Media personality.
Comparisons count (e.g., unique comparisons excluding repeat comparisons with the same user).
Number of artists stored on the user device.
Artist with the greatest number of media items on the user device.
Number of media items on the user device.
Number of genres on the user device.
Genre with the greatest number of media items.
Number of media items not found on a hit media list.
Whether or not user rates media.
Number of media items skipped.

Music comparison items:
Compatibility test result(s) (e.g., 0-180 score).
Identifier of other user.
Number of media items matched.
Name of top matched media item and artist.
Yes/No if matching genre.
Yes/No if average media year is within a specified range between the average release years of both the users doing the comparison.
Musical score of the other user.
Media personality of the other user.
Yes/No if they have the same top ranked media items.
Yes/No if they have the same top played media items.
Yes/No if they have the same top ranked artist.
Yes/No if they have the same top played artist.
Number of matching artists.
Number of media items that match in the recently played lists.

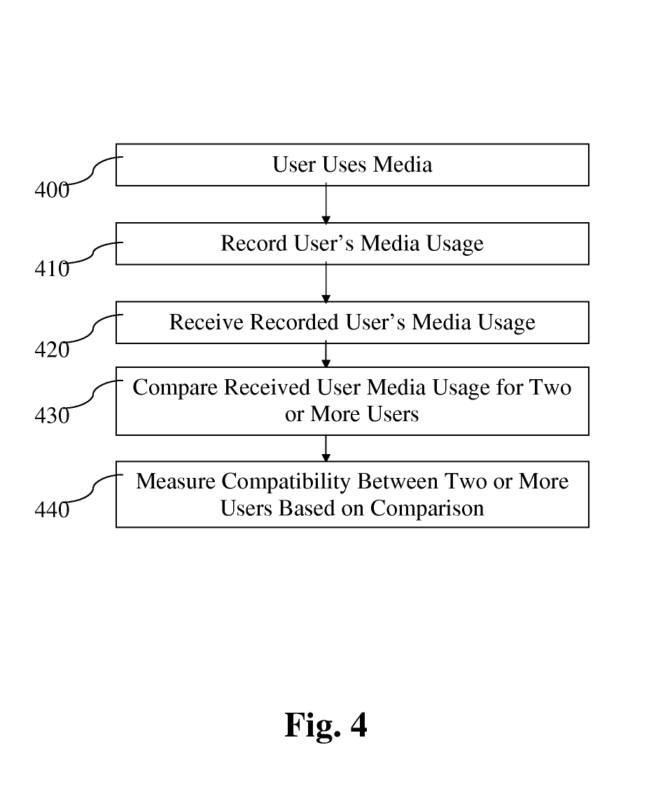

Reference is made to FIG. 4, which is a flowchart illustration of a method in accordance with an embodiment of the invention. The method of FIG. 4 may be executed by devices in system 100 of FIG. 1

In operation 400, a user or user device (e.g., user device 140 or 150 of FIG. 1) may use media, for example, loaded from a media server (e.g., media server 110 of FIG. 1) over a network (e.g., network 120 of FIG. 1) or stored locally in the user device (e.g., in memory unit 148 or 158 of FIG. 1).

In operation 410, the usage of media by the user or user device may be recorded. The media usage may be recorded, for example, locally by the user device components (e.g., media players, storage or memory units, program files, etc.) or remotely at an analysis module (e.g., analysis module 130 of FIG. 1) using a passive sniffer or a web crawler.

In operation 420, information of the recorded usage of media by two or more users or user devices may be received, for example, by the analysis module, for example, stored locally in the user devices as an application or remotely in a remote analysis server.

In operation 430, the received recorded media usage for the users or user devices may be compared by the analysis module.

In operation 440, a measure of compatibility may be determined between the two or more users or user devices based on the comparison by the analysis module. In one embodiment, the analysis module may determine if the users or user devices are compatible if the processor comparison defines a sufficiently close media usage between the two or more users or user devices.

Although embodiments of the invention describe social compatibility by users' media usage, such embodiments may be applied to any field and any data type. For example, in the professional world, a job candidate may establish compatibility for a position at a company, college or firm, not based on their own resume, which may be embellished for their benefit, but using a device or method according to embodiments of the invention providing a record of their actual work history, professional reviews and achievements. In the financial field, loan or credit card applicants may be evaluated for credit risk based on their actual credit histories, credit scores, etc. In the medical field, patients may be matched with doctors or hospitals, donor applicants with donors, or patients with each other in a support group environment, based on their actual medical evaluations or tests results. In certain fields such as the financial and medical fields, although candidate matches and/or compatibility scores are generally available, some of the input information may be kept private in accordance with confidentiality requirements or standards for that field. Still other embodiments of the invention may determine device (not user) compatibility, for example, based on their operating systems, latest versions of programs installed, hardware, software, device interfaces, etc.

The application may allow a user to switch or toggle between different languages, and any application specific messages may conform to the selected language.

Different embodiments are disclosed herein. Features of certain embodiments may be combined with features of other embodiments; thus certain embodiments may be combinations of features of multiple embodiments.

Embodiments of the invention may include an article such as a computer or processor readable non-transitory storage medium, such as for example a memory, a disk drive, or a USB flash memory encoding, including or storing instructions, e.g., computer-executable instructions, which when executed by a processor or controller, cause the processor or controller to carry out methods disclosed herein.

The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

What is claimed is:

1. A method for determining user compatibility, the method comprising:
receiving information recording the usage of media by two or more users at associated user devices;
comparing the recorded media usage for the users; and
determining a measure of compatibility between the two or more users based on the comparison.

2. The method of claim 1 comprising selecting one of a plurality of personality types to assign to each of one or more of the users based on the recorded media usage for the user.

3. The method of claim 1 comprising selecting one of a plurality of media proficiency levels to assign to each of one or more of the users based on the recorded media usage for the user.

4. The method of claim 1, wherein comparing comprises analyzing recorded media usage selected from the group consisting of: total number of media items, total number of different artists, total number of different genres, genre with most media items, artist with the most media items, artist with the most media played, genre with the highest percentage of user media, favorite artist, favorite genre, favorite media items, most played media items, most played artists, number of media items found in a hits list, most played media items excluding media items found in the hits list, most skipped media items, most recently played media items.

5. The method of claim 1 comprising searching for other users' devices operating the compatibility test using geo-location.

6. The method of claim 1 comprising triggering the compatibility test by selecting a compare button on the associated user devices.

7. The method of claim 1 comprising displaying results of the comparison selected from the group consisting of: a measure of the compatibility of the users, media that the users have in common, and media that the users do not have in common.

8. The method of claim 1, wherein media includes a media type selected from the group consisting of: music, video, images, multi-media data, e-books, television, video games, and Internet data.

9. The method of claim 1, wherein the users' media usage information is compared locally at one of the user devices.

10. The method of claim 1, wherein the users' media usage information is compared remotely at a server.

11. A system for determining user compatibility, the system comprising:
a memory to store media usage data; and
a processor to receive information recording the usage of media by two or more users at associated user devices, to compare the recorded media usage for the users, and to determine if the users are compatible if the processor comparison defines a sufficiently close media usage between the two or more users.

12. The system of claim 11 comprising a passive sniffing device to record each user's media usage information.

13. The system of claim 11 comprising a media player application to record each user's media usage information.

14. The system of claim 11 comprising a media storage database to record each user's media usage information.

15. The system of claim 11 comprising a geo-location device to search for other users' devices operating the compatibility test.

16. The system of claim 11, wherein the user devices include a compare button to trigger the compatibility test between the user devices.

17. The system of claim 11 comprising a display to display results of the comparison selected from the group consisting of: a measure of the compatibility of the users, media that the users have in common, and media that the users do not have in common.

18. The system of claim 11, wherein the user devices compare the users' media usage information locally.

19. The system of claim 11 comprising a server to compare the users' media usage information remotely.

20. The system of claim 11, wherein media includes a media type selected from the group consisting of: music, video, images, multi-media data, e-books, television, video games, and Internet data.
